(19) United States
(12) Patent Application Publication
(10) Pub. No.: US 2024/0256856 A1
(43) Pub. Date: Aug. 1, 2024

(54) DEPLOYING NEURAL NETWORK MODELS ON RESOURCE-CONSTRAINED DEVICES

(71) Applicant: SONY GROUP CORPORATION, TOKYO (JP)

(72) Inventors: KRISHNA PRASAD AGARA VENKATESHA RAO, BANGALORE (IN); AKSHAY SHEKHAR KADAKOL, Bangalore (IN); PRAJOT S. KUVALEKAR, Bangalore (IN); ANKITA K. R, Bangalore (IN); DEV PRASAD KODE, Bangalore (IN)

(21) Appl. No.: 18/160,680

(22) Filed: Jan. 27, 2023

(51) Int. Cl. G06N 3/08; G06N 3/04

(52) U.S. Cl. CPC G06N 3/08; G06N 3/04

(57) ABSTRACT

A method for deploying neural network models on resource-constrained devices is provided. The method includes storing a model file that includes a neural network model and determining constraint information associated with deployment of the neural network model on the electronic device. The method further includes determining a partition of the neural network model based on the constraint information and the model file and extracting sub-models from the neural network model based on the partition. The method further includes receiving an input associated with a machine learning task and executing operations for loading a sub-model in a working memory of the electronic device, applying the sub-model on the input to generate an intermediate result, and unloading the sub-model from the working memory. The method further includes executing the operations for a next sub-model to generate an output and rendering the output. The intermediate result is an input for the next sub-model.

### CROSS-REFERENCE TO RELATED APPLICATIONS/INCORPORATION BY REFERENCE

None.

### FIELD

Various embodiments of the disclosure relate to machine learning (ML) model deployment and memory management for ML inference. More specifically, various embodiments of the disclosure relate to deployment of neural network models on resource-constrained devices.

### BACKGROUND

Advancements in computing have led to development of machine learning models for variety of machine learning tasks. The amount of memory that may be required to perform a machine learning task may depend on the complexity and scope of the machine learning task. This is because the size of a DNN model to be used to perform a machine learning task may increase based on the complexity of the machine learning task. A resource-constrained device (e.g., a memory-constrained computing device) may be required to have sufficient memory to load the DNN model, perform computations for the machine learning task, and store intermediate results associated with the computations. Some machine learning tasks may be computationally intensive and may involve several operations in parallel. Therefore, the resource-constrained computing device may require substantial processing capability to perform such tasks. For example, an edge device may be treated as a resource-constrained device because of its limited memory, bandwidth, or processing capability. Since the edge device is constrained by its memory and/or processing capability, the type of machine learning tasks that can be performed on the edge device using the DNN model may be limited by a size and a complexity of the machine learning tasks. To overcome this restriction, the DNN model may be quantized or pruned. However, the quantization or pruning may compromise the accuracy or efficiency of the DNN model.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for deployment of neural network models on resource-constrained devices, is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates an exemplary network environment for deployment of neural network models on resource-constrained devices, in accordance with an embodiment of the disclosure.

FIG. 2 is a block diagram that illustrates an exemplary first electronic device for deployment of neural network models on resource-constrained devices, in accordance with an embodiment of the disclosure.

FIG. 3 is a diagram that illustrates an exemplary scenario for extraction of a plurality of sub-models from a Deep Neural Network (DNN) model based on constraint information, in accordance with an embodiment of the disclosure.

FIG. 4 is a diagram that illustrates an exemplary scenario about execution of a set of operations for each sub-model extracted from a neural network model, in accordance with an embodiment of the disclosure.

FIG. 5 is a diagram that illustrates an exemplary scenario for extraction of a plurality of sub-models from a DNN model and application of the plurality of sub-models on a plurality of devices, in accordance with an embodiment of the disclosure.

FIG. 6 is a diagram that illustrates an exemplary scenario for extraction of sub-models from a DNN model based on input received at each layer of the DNN model, in accordance with an embodiment of the disclosure.

FIG. 7 is a diagram that illustrates an exemplary scenario for rendering of a partition of a DNN model, in accordance with an embodiment of the disclosure.

FIG. 8 is a flowchart that illustrates operations for an exemplary method for deployment of neural network models on resource-constrained devices, in accordance with an embodiment of the disclosure.

### DETAILED DESCRIPTION

The following described implementations may be found in a disclosed method and system for deployment of neural network models on resource-constrained devices. Exemplary aspects of the disclosure provide a method that may be implemented on an electronic device (i.e., a resource-constrained device) to obtain an optimal partition of a neural network model (such as a deep neural network (DNN)) stored on the electronic device. The method may include storing, on a persistent storage (for example, a non-volatile memory, a flash memory, or a secure digital memory) of the electronic device, a model file that includes the neural network model. The method may further include determining constraint information associated with a deployment of the neural network model on the electronic device. For example, the constraint information may include a memory footprint of the neural network model, a size of a working memory of the electronic device, or a processing capability of the electronic device. The method may further include determining a partition of the neural network model (i.e., a number of sub-models into which the neural network model must be partitioned and a size of each sub-model in the partition) based on the constraint information and the model file. Thereafter, the method may include extracting a plurality of sub-models from the neural network model based on the partition and receiving an input (for example, an image file, an audio file, a video file, or a structured dataset or unstructured dataset) that may be associated with a machine learning task (such as face recognition, voice recognition, feature detection, object detection, sentiment analysis, emotion classification, and so on). The method may further include executing a set of operations for a sub-model of the plurality of sub-models. The set of operations may include, for example, an operation to load the sub-model in the working memory of the electronic device, an operation to generate an intermediate result by an application of the loaded sub-model on the input, and an operation to remove the loaded sub-model from the working memory of the electronic device (after generation of the intermediate result). The method may further include repeating the execution of the set of operations for a subsequent sub-model of the plurality of sub-models to produce an output of the neural network model. The intermediate result may be the input for the subsequent sub-model. The method may finally include controlling a display device to render the output.

Some devices, especially networking devices or edge devices may have resource constraints such as a limited working memory (i.e., a limited volatile memory), a limited processing capability, or a limited networking capability for typical machine learning tasks. For such tasks, such resource constraints can lead to issues in the deployment of neural network models on the resource-constrained devices (e.g., battery-operated AI devices or edge devices). The issues typically arise because the neural models require a significant amount of device memory and processing power for inference. The requirement of the neural network models for the resources may increase based on a type, a scope, or a complexity of the machine learning tasks that may need to be performed by the neural network models. Existing battery-operated AI devices or edge devices may not be able to meet the requirement due to several resource constraints. For example, the model may not fit into working memory of such devices. To mitigate the issues in deployment of neural network models, the neural network models may be quantized or pruned. The quantization or pruning of the neural network models may reduce resource requirements of the neural network models. However, the quantization or pruning may lead to a loss of accuracy or efficiency on the part of the neural network models. The quantization or pruning may need to be performed based on a configuration that may be specific for a resource-constrained device. Further, reversing effects of the quantization or pruning on the accuracy may require a manual tuning. The manual tuning of the neural network models may be cumbersome and may require involvement of domain experts.

If the quantization or pruning of the neural network models is not performed, the resource-constrained device may avail services from cloud servers or third-party devices that offer such services. For example, to perform face recognition (which is a machine learning task), a resource-constrained device may send an image to a cloud-based server. The cloud server may perform the face recognition based on the received image and may transmit face recognition data to the resource-constrained device. However, the cloud-based server may extract additional information from the received image for the purpose of selling the additional information to a third-party for monetary benefits. This creates a privacy issue for people or organizations associated with the image. Even if a machine learning task does not involve sensitive data, considerable latency may be involved in obtaining a result if data is required to be transmitted to other devices or servers for execution of machine learning tasks. The latency may depend on transmission and reception bandwidths of each resource-constrained device and processing capability of each resource-constrained device.

To address the issues of deployment of Deep Neural Network (DNN) models on resource-constrained devices, the proposed method may split or partition an original neural network model into multiple light-weight sub-models. The partitioning may involve an analysis of each layer of a set of layers of the neural network model for determination of a memory footprint of the corresponding layer. Based on the analysis, the electronic device may determine a partition for extraction of a plurality of sub-models from the neural network model. The determined partition may be such that memory requirement for loading a sub-model (of the plurality of sub-models), and an input to the sub-model and an output that may be generated by the sub-model are less than or equal to a working memory of the electronic device. The partitioning may thus allow the electronic device (i.e., a resource-constrained device) to overcome a memory constraint in the deployment of the neural network model. At any time, a sub-model may be loaded on a working memory of the electronic device along with an input (the size of the input may depend on a first layer (or an input layer) of the sub-model). The sub-model may generate an output. Once the output is generated, the sub-model may be unloaded from the working memory, a subsequent sub-model may be loaded on the working memory, and the generated output may be provided as an input to the subsequent sub-model. The loading and unloading of the sub-models may continue until a final output is generated. The final output that may be generated using the partitioned neural network model may be same as the one which the original neural network model (i.e., unpartitioned model) may generate Thus, the partitioning of the original neural network model may not compromise the accuracy of neural network model during an inference stage.

In some scenarios, the partitioning may be such that the electronic device can perform a required number of computations (for example, multiply-accumulate (MAC) operations) at a time for each sub-model while the sub-model is loaded in the working memory. Thus, the partitioning may allow the electronic device to overcome shortcomings associated with a processing capability constraint.

In certain embodiments, the neural network model may be partitioned into the plurality sub-models based on inputs that may be provided to each sub-model of the plurality sub-models and a network communication capability of the electronic device. One or more sub-models of the plurality sub-models and inputs to be provided to the sub-models may be transmitted to other electronic devices. The electronic device may ensure that the transmitted input does not include personal or sensitive information and each of the transmitted one or more sub-models do not require any personal or sensitive information (as input) to perform operations associated with the transmitted one or more sub-models. Such partitioning of the neural network model based on input content may ensure that privacy constraints associated with users or customers of the electronic device are taken care of. Those sub-models that use personal or sensitive information as input may not be transmitted to a cloud-based server or any other third-party device and may infer results locally on the electronic device. The electronic device may further ensure that one or more sub-models are transmitted to other electronic devices with a tolerable transmission latency. The memory requirement for loading and executing each of the transmitted one or more sub-models must remain less than or equal to a working memory of the other electronic devices.

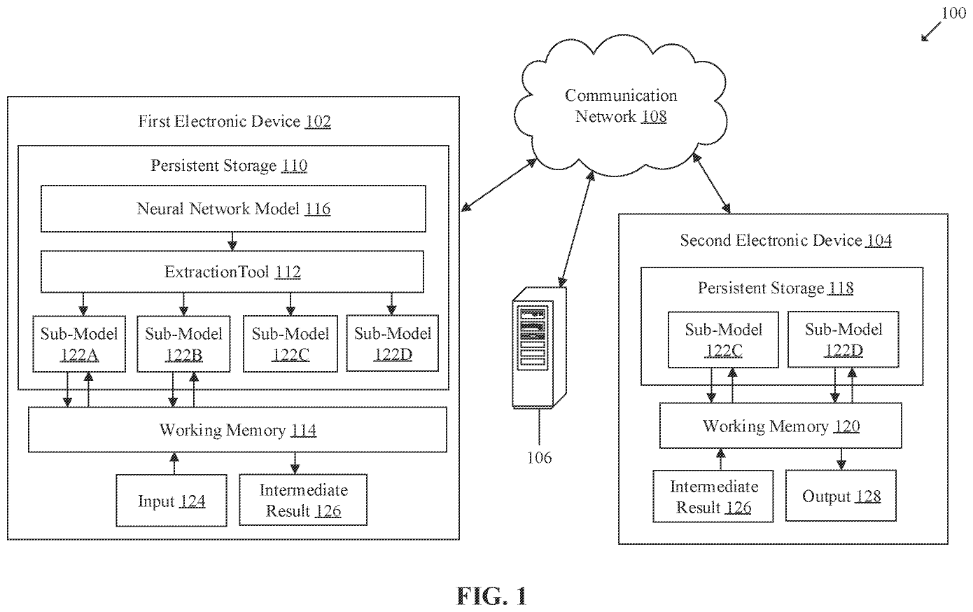

FIG. 1 is a diagram that illustrates an exemplary network environment for deployment of neural network models on resource-constrained devices, in accordance with an embodiment of the disclosure. With reference to FIG. 1, there is shown a network environment 100. The network environment 100 includes a first electronic device 102, a second electronic device 104, and a server 106. The first electronic device 102 may communicate with the second electronic device 104 and the server 106, through one or more networks (such as a communication network 108). The first electronic device 102 may include a persistent storage 110, an extraction tool 112, and a working memory 114. The persistent storage 110 may store a neural network model 116 (for example, a Deep Neural Network (DNN) model). The second electronic device 104 may similarly include a persistent storage 118 and a working memory 120.

The extraction tool 112 may include suitable logic, circuitry, interfaces, and/or code that, when executed on the first electronic device 102, may extract a plurality of sub-models (for example, four sub-models 122A, 122B, 122C, and 122D) from the neural network model 116. The first electronic device 102 may transmit the sub-model 122A and the sub-model 122B to the second electronic device 104. The first electronic device 102 may apply the sub-model 122A on an input 124 and the sub-model 122B may generate an intermediate result 126 (based on an output of the sub-model 122A). Similarly, the second electronic device 104 may apply the sub-model 122C on the intermediate result 126 and the sub-model 122D may generate an output 128 (based on an output of the sub-model 122C). The first electronic device 102 may partially perform a machine learning task to generate the intermediate result 126 based on the input 124. Similarly, the second electronic device 104 may partially perform the machine learning task to generate the output 128 based on the intermediate result 126.

The first electronic device 102 is shown in FIG. 1 to extract four sub-models 122A, 122B, 122C, and 122D merely as an example and such an example should not be construed as limiting the disclosure. The first electronic device 102 may be configured to extract any number of sub-models from a neural network model (such as the neural network model 116). Similarly, the transmission of two sub-models (i.e., the sub-models 122C and 122D) to the second electronic device 104 is shown in FIG. 1 merely as an example and such an example should not be construed as limiting the disclosure. The first electronic device 102 may transmit any number of sub-models to any number of electronic devices (which may include the second electronic device 104).

In some embodiments, the network environment 100 may include more than two electronic devices. The output 128 (i.e., a final output of the neural network model 116) may be generated by one of electronic device of the plurality of electronic devices. In some other embodiments, the first electronic device 102 may not transmit any sub-model to other electronic devices. In such a scenario, the network environment 100 may include only the first electronic device 102 and the output 128 may be generated by the first electronic device 102.

The first electronic device 102 may include suitable logic, circuitry, interfaces, and/or code that may be configured to extract sub-models (such as the plurality of sub-models 122A-122D) from the neural network model 116. The extraction may be based on a partition of the neural network model 116. The partition may be determined based on a model file that includes the neural network model 116 and constraint information that may be associated with the first electronic device 102. The first electronic device 102 may sequentially apply the extracted sub-models on the input 124 or intermediate outputs generated by the extracted sub-models to perform a machine learning task fully or partially. Examples of the first electronic device 102 may include, but are not limited to, a computing device, an edge device, a network device, an Internet of Things (IoT) device, a smartphone, a mobile phone, a tablet, a smart wearable device, a mainframe machine, a surveillance equipment (such as a camera or a drone), a computer workstation, sensors in an autonomous vehicle, an internet of things (IoT) device, and/or a consumer electronic (CE) device.

The second electronic device 104 may include suitable logic, circuitry, interfaces, and/or code that may be configured to receive sub-models (such as the sub-model 122C and the sub-model 122D) and the intermediate result 126 from the first electronic device 102. The second electronic device 104 may partially perform or may complete a remaining part of the machine learning task to generate the output 128. The second electronic device 104 may apply the sub-model 122C on the intermediate result 126 to generate an intermediate output. The sub-model 122D may be applied on the intermediate output to obtain the output 128. In some embodiments, the second electronic device 104 may transmit the output 128 to the first electronic device 102. Examples of the second electronic device 104 may include, but may not be limited to, a computing device, an edge device, a network device, an IoT device, a smartphone, a mobile phone, a tablet, a smart wearable device, a mainframe machine, a surveillance equipment (such as a camera or a drone), a computer workstation, sensors in an autonomous vehicle, an IoT device, and/or a CE device.

The server 106 may include suitable logic, circuitry, interfaces, and/or code that may be configured to store neural network models (such as the neural network model 116). The server 106 may receive a request from the first electronic device 102 to import the neural network model 116. The server 106 may transmit the neural network model 116 to the first electronic device 102 based the received request. In some embodiments, the server 106 may store the extraction tool 112 and receive, from the first electronic device 102, data such as the input 124, the neural network model 116, and a request for extraction of sub-models from the neural network model 116. The server 106 may execute the extraction tool 112 to extract the plurality of sub-models 122A-122D from the neural network model 116. Thereafter, the server 106 may transmit the extracted plurality of sub-models 122A-122D to the first electronic device 102.

The server 106 may execute operations through web applications, cloud applications, HTTP requests, repository operations, file transfer, and the like. Example implementations of the server 106 may include, but are not limited to, a database server, a file server, a web server, an application server, a mainframe server, a cloud computing server, or a combination thereof. In at least one embodiment, the server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106 and the first electronic device 102 as two separate entities. In certain embodiments, the functionalities of the server 106 can be incorporated in its entirety or at least partially in the first electronic device 102, without a departure from the scope of the disclosure.

The communication network 108 may include a communication medium through which the first electronic device 102, the second electronic device 104, and the server 106 may communicate with each other. The communication network 108 may be a wired or wireless communication network. Examples of the communication network 108 may include, but are not limited to, Internet, a Wireless Fidelity (Wi-Fi) network, a Personal Area Network (PAN), a Local Area Network (LAN), or a Metropolitan Area Network (MAN). The first electronic device 102 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The persistent storage 110 may be configured to store program instructions and/or process data that may be interpreted and/or executed by the first electronic device 102. The persistent storage 110 may store the extraction tool 112, the neural network model 116, and the plurality of sub-models (i.e., sub-models 122A, 122B, 122C, and 122D) extracted using the extraction tool 112. The persistent storage 110 may further store an input (such as the input 124) that triggers a machine learning task and intermediate results (such as an output generated by the sub-model 122A and an output generated by the sub-model 122B (i.e., the intermediate result 126)).

The extraction tool 112 may be a computer-executable program that may be executable on the first electronic device 102 or may be accessible via a web client installed on the first electronic device 102. The extraction tool 112, when executed on the first electronic device 102, may retrieve the neural network model 116 from the persistent storage 110 for analysis of the neural network model 116. In some embodiments, the extraction tool 112 may receive the neural network model 116 from the first electronic device 102 for the analysis. The analysis may include, for example, a determination of a memory footprint of the neural network model 116, a memory footprint of each neural network (NN) layer of a set of NN layers of the neural network model 116, a number of operations associated with each NN layer, a bandwidth requirement for transmission or reception of each NN layer, or an input that may be received by each NN layer. Based on the analysis, the extraction tool 112 be executed to determine a partition that indicates number of sub-models into which the neural network model 116 may be partitioned. Thereafter, the extraction tool 112 may be executed to extract the plurality of sub-models 122A-122D based on the partition.

The working memory 114 may refer to a portion of a volatile memory or a non-persistent storage of the first electronic device 102 that is available at any time-instant for temporary storage and/or execution of a set of program instructions. The size of the working memory 114 may depend on a number of applications or processes that may be operational on the first electronic device 102 at a given time instant. For example, if Random Access Memory (RAM) of an imaging device is 256 MB and 250 MB out of 256 MB is occupied by imaging applications and processes of an operating system, then the working memory 114 may be equal to 6 MB (i.e., 256 MB-250 MB).

The working memory 114 may store one or more instructions to be executed by the first electronic device 102. Such instructions may be executed by the first electronic device 102 to perform operations, such as a determination of a partition of the neural network model 116, an extraction of sub-models from the neural network model 116, an execution of a set of operations for each of the extracted sub-models for generation of an intermediate result or an output (based on an input or one or more intermediate results), or a rendering of the output on a display device. The first electronic device 102 may load the extracted sub-models sequentially in the working memory 114. Once a sub-model is loaded in the working memory 114, the sub-model may be applied on the input or an intermediate result to generate another intermediate result or a final output. Thereafter, the sub-model may be unloaded from the working memory 114 and a next sub-model may be loaded into the working memory 114.

The neural network model 116 may be a computational network or a system of artificial neurons that may be arranged in a plurality of layers. The plurality of layers of the neural network model 116 may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network model 116. Outputs of each hidden layer may be coupled to inputs of at least one node in other layers of the neural network model 116. Node(s) in the final layer may receive inputs from at least one hidden layer to output a result. The number of layers and the number of nodes in each layer may be determined from hyper-parameters of the neural network model 116. Such hyper-parameters may be set before or after training the neural network model 116 on a training dataset.

Each node of the neural network model 116 may correspond to a mathematical function (e.g., a sigmoid function or a rectified linear unit) with a set of parameters tunable during training of the neural network model 116. The set of parameters may include, for example, a weight parameter, a regularization parameter, and the like. Each node may use the mathematical function to compute an output based on one or more inputs from nodes in other layer(s) (e.g., previous layer(s)) of the neural network model 116. All or some of the nodes of the neural network model 116 may correspond to same or a different mathematical function. In training of the neural network model 116, one or more parameters of each node of the neural network model 116 may be updated based on whether an output of the final layer for a given input (from the training dataset) matches a correct result based on a loss function for the neural network model 116. The above process may be repeated for same or a different input until a minima of the loss function is achieved, and a training error is minimized. Several methods for training are known in art, for example, gradient descent, stochastic gradient descent, batch gradient descent, gradient boost, meta-heuristics, and the like.

The neural network model 116 may include electronic data, which may be implemented as, for example, a software component of an application executable on the first electronic device 102. The neural network model 116 may rely on libraries, external scripts, or other logic/instructions for execution by a processing device, such as the first electronic device 102. The neural network model 116 may function as a DNN model with a capability to perform machine learning tasks (such as regression tasks, clustering tasks, classification tasks, generative tasks (e.g., image-to-image translation or natural language synthesis), or dimensionality reduction tasks) for a variety of applications (such as face recognition, audio analysis, voice or speech recognition, sentiment mining, traffic prediction, natural language processing, product recommendation, emotion classification, and so on).

The neural network model 116 may include code and routines that may be configured to enable a computing device, such as the first electronic device 102 to perform operations associated with the machine learning tasks. Additionally, or alternatively, the neural network model 116 may be implemented using hardware including but not limited to, a processor, a microprocessor (e.g., to perform or control performance of one or more operations), a co-processor (such as an Inference Accelerator), a field-programmable gate array (FPGA), or an application-specific integrated circuit (ASIC). Alternatively, in some embodiments, the neural network model 116 may be implemented using a combination of hardware and software. Examples of the neural network model 116 may include, but are not limited to, a convolutional neural network (CNN), an artificial neural network (ANN), a fully connected neural network, a deep Bayesian neural network, a recurrent neural network, a transformer network, an autoencoder, a Graph Neural Network, a Generative Adversarial Network (GAN), and/or a combination of such networks. In some embodiments, the neural network model 116 may correspond to a learning engine that may execute numerical computations using data flow graphs. In certain embodiments, the neural network model 116 may be based on a hybrid architecture of multiple DNNs.

The persistent storage 118 may be configured to store program instructions and/or process data that may be interpreted and/or executed by the second electronic device 104. The persistent storage 118 may store one or more sub-models (for example, the sub-models 122C and 122D) and an input (for example, the intermediate result 126) received from the first electronic device 102. The persistent storage 110 may further store intermediate inputs/outputs (such as an input generated by the sub-model 122C and the output 128 generated by the sub-model 122D).

The working memory 120 may be similar to the working memory 114 and may include suitable logic, circuitry, and interfaces that may be configured to store one or more instructions to be executed by the second electronic device 104. Such instructions may be executed by the second electronic device 104 to perform operations such as a reception of data (such as one or more extracted sub-models, an input, or an intermediate result from the first electronic device 102), an execution of a set of operations for each received sub-model for the generation of an intermediate result or an output (based on the input or an intermediate result that may be generated a received sub-model), a rendering of the output on a display device, or a transmission of the output to the first electronic device 102. The second electronic device 104 may sequentially load the received sub-models into the working memory 120. Once a sub-model is loaded into the working memory 120, the sub-model may be applied on the input or an intermediate result (obtained from another sub-model) to generate another intermediate result or an output. Thereafter, the sub-model may be unloaded from the working memory 120 and a next sub-model may be loaded into the working memory 120.

Each sub-model of the plurality of sub-models 122A-122D may be extracted from the neural network model 116 and may include at least one layer of the neural network model 116. Each of the plurality of sub-models 122A-122D may receive an input (such as the input 124 or the intermediate result 126) and may generate an output (such as the intermediate result 126 or the output 128). For example, the sub-model 122A may receive the input 124. The sub-model 122B may generate the intermediate result 126 as an output. The sub-model 122C may receive the intermediate result 126 as an input and the sub-model 122D may generate the output 128. Further, an intermediate result (not shown) as an output of the sub-model 122A may be received as an input by the sub-model 122B. Similarly, an intermediate result (not shown) generated as an output of the sub-model 122C may be received as an input by the sub-model 122D. The output 128 may be identical to a final output that may be generated by application of the neural network model 116 (i.e., a model without any partition) on the input 124.

In operation, the first electronic device 102 may be configured to store, on the persistent storage 110 of the first electronic device 102, a model file that includes the neural network model 116. In the context of neural networks, a model file typically refers to a file that stores trained weights and biases of a neural network. These weights and biases may be learned during the training process and may be used to make predictions on new data. The model file may be also used to restore the trained neural network and use the restored network for inference or further fine-tuning of the neural network. Example of different file formats that can be used to store the neural network model 116 may include, but is not limited to, HDF5, TensorFlow® SavedModel format, PyTorch® native serialization format, and the like. In general, the choice of the file format may depend on the programming language and deep learning framework that is used to develop the model.

The extraction tool 112, when executed on the first electronic device 102, may retrieve the model file from the persistent storage 110. In some embodiments, the retrieval of the model file from the persistent storage 110 may be based on a reception of a user input via a user interface associated with the first electronic device 102. The first electronic device 102 may be configured to determine a size of the neural network model 116, a count of neural network (NN) layers of the neural network model 116, and a memory footprint of the neural network model 116 based on the model file. The memory footprint of the neural network model 116 may be indicative of an amount of memory required to load the neural network model 116 into the working memory 114 of the first electronic device 102. The required memory may be determined based on the size of the neural network model 116, a size of the input 124, a size of each intermediate output generated at an input layer or each intermediate NN layer of the neural network model 116, or a size of an output generated by an output layer of the neural network model 116. For example, the size of the neural network model 116 may be determined as 646 KB (Kilo Bytes) while the memory footprint of the neural network model 116 may be determined as 1350 KB. The count of NN layers of the neural network model 116 may be determined as 10 (i.e., NN layers 1-10), for example.

The first electronic device 102 may be further configured to determine constraint information associated with a deployment of the neural network model 116 on the first electronic device 102. The constraint information may include, for example, a size of the working memory 114 of the first electronic device 102, a processing capability of the first electronic device 102 to perform a count of multiply-accumulate (MAC) operations per second, a network communication capability indicative of transmission and reception bandwidths of the first electronic device 102, an indication that the input 124 includes personal or sensitive data, and the like. In some embodiments, the constraint information may be determined based on a user input received via the user interface associated with the extraction tool 112. For example, the first electronic device 102 may determine the size of the working memory 114 as 1000 KB, the processing capability to perform about 350 million MACs per second, and the network communication capability as 500 KB/sec (KB per second) for Bluetooth®, 2 MB/sec (million Bytes per second) for Wi-Fi (wireless fidelity), and 5 MB/sec for wired connections.

The first electronic device 102 may be further configured to determine a partition of the neural network model 116 based on the constraint information and the model file. The partition may be determined if the memory footprint of the neural network model 116 is greater than the size of the working memory 114. For example, the memory footprint of the neural network model 116 may be 1350 KB which is greater than the size of the working memory 114, i.e., 1000 KB.

To determine the partition, the first electronic device 102 may analyze the model file, i.e., each NN layer of the neural network model 116. The analysis of each NN layer may include a determination of a memory footprint of a corresponding NN layer of a set of layers (10 layers for example), a count of MAC operations associated with the corresponding NN layer, a bandwidth requirement for transmission of the corresponding NN layer, and an indication that determines whether the corresponding NN layer receives the input 124 (if the input 124 includes personal or sensitive data). The memory footprint of each NN layer may indicate a memory required to load a corresponding NN layer in the working memory 114 as part of a sub-model of the plurality of sub-models 122A-122D. In accordance with an embodiment, the memory footprint of each NN layer may be determined based on a size of the corresponding NN layer, a size of an input that may be received by the corresponding NN layer, a size of an output to be generated by the corresponding NN layer, and/or a size of a buffer that may be allocated to the corresponding NN layer.

In accordance with an embodiment, the first electronic device 102 may determine that the memory footprint of each NN layer of the set of NN layers of the neural network model 116 is less than or equal to the size of the working memory 114 of the first electronic device 102 based on the analysis. The count of MAC operations associated with each NN layer may be less than or equal to the processing capability of the first electronic device 102. Further, the bandwidth requirement for the transmission of each NN layer may be less than or equal to a network communication capability of the first electronic device 102.

In accordance with an embodiment, the first electronic device 102 may be configured to group adjoining NN layers of the set of NN layers into a plurality of subsets of NN layers based on memory footprint of each NN layer, the count of MAC operations associated with each NN layer, the bandwidth requirement for transmission of each NN layer, and whether a corresponding NN layer receives the input 124. For example, NN layer 1 (i.e., the input NN layer) of the neural network model 116 may be adjoining to NN layer 2 (an intermediate NN layer), and NN layer 2 may be adjoining to NN layer 3 (an intermediate NN layer). Similarly, NN layer 9 (an intermediate NN layer) may be adjoining to NN layer 10 (i.e., the output NN layer). The first electronic device 102 may group NN layer 1, NN layer 2, and NN layer 3, into a first subset of the plurality of subsets of NN layers. Similarly, NN layer 4 and NN layer 5 may be a grouped into a second subset, NN layer 6 and NN layer 7 may be a grouped into a third subset, and NN layer 8, NN layer 9, and NN layer 10 may be a grouped into a fourth subset. The first electronic device 102 may determine the partition based on the grouping of the adjoining NN layers of the set of NN layers into the plurality of subsets of NN layers.

The memory footprint of each subset (such as the first subset) of the plurality of subsets (for example, four subsets) of NN layers may be a sum of memory footprints of adjoining NN layers (such as NN layers 1, 2, and 3) of the set of NN layers (10 NN layers) that may be grouped into a corresponding subset of the plurality of subsets. The memory footprint of each subset (such as the first subset) may be less than or equal to the size of the working memory 114 of the first electronic device 102. For example, the first electronic device 102 may accumulate a memory footprint of each of NN layer 1 and NN layer 2 to obtain a first combined memory footprint. The first electronic device 102 may further accumulate the first combined memory footprint and a memory footprint of NN layer 3 to obtain a second combined memory footprint. Each of the first combined memory footprint and the second combined memory footprint may be compared with the working memory 114. The first electronic device 102 may group NN layer 1 and NN layer 2 (i.e., adjoining NN layers) if the first combined memory footprint is less than the working memory 114 and the second combined memory footprint is greater than the working memory 114. The grouping of NN layers 1 and 2 may be a first subset of NN layers of the plurality of subsets of NN layers. The first electronic device 102 may accumulate the second combined memory footprint and a memory footprint of NN layer 4 to obtain a third combined memory footprint, if the second combined memory footprint is less than the working memory 114. The first electronic device 102 may group NN layers 1, 2, and 3 (i.e., adjoining NN layers) if the third combined memory footprint is greater than the working memory 114. The grouping of NN layers 1, 2, and 3 may be referred to as the first subset of NN layers of the plurality of subsets of NN layers. Similarly, other layers of the neural network model 116 may be grouped to form the plurality of subsets of adjoining NN layers based on the determined memory footprint of each NN layer. The first electronic device 102 may determine the partition of the neural network model 116 based on the grouping of the adjoining NN layers into the plurality of subsets of NN layers.

The grouping of adjoining NN layers of the set of NN layers into the plurality of subsets of NN layers may be further based on the count of MAC operations associated with each NN layer (that is determined during the analysis of the neural network model 116). For example, the first electronic device 102 may accumulate a count of MAC operations associated with each of NN layer 1 and NN layer 2 to obtain a first combined count. The first electronic device 102 may further accumulate the first combined count and a count of MAC operations associated with NN layer 3 to obtain a second combined count. Each of the first combined count and the second combined count may be compared with the processing capability of the first electronic device 102 (i.e., a part of the constraint information). The first electronic device 102 may group NN layer-1 and NN layer-2 if the first combined count is less than the processing capability and the second combined count is greater than the processing capability. The grouping of NN layers 1 and 2 may be referred to as the first subset of NN layers. The first electronic device 102 may accumulate the second combined count and a count of MAC operations associated with NN layer-4 to obtain a third combined count if the second combined count is less than the processing capability. The first electronic device 102 may group NN layers 1, 2, and 3 if the third combined count is greater than the processing capability. The grouping of NN layers 1, 2, and 3 may be referred to as the first subset of NN layers of the plurality of subsets of NN layers. Similarly, other layers of the neural network model 116 may be grouped into the plurality of subsets of adjoining NN layers based on the determined processing capability of the first electronic device 102. Thus, the first electronic device 102 may determine the partition of the neural network model 116 based on the grouping of the adjoining NN layers into the plurality of subsets of NN layers.

The count of MAC operations associated with a subset (such as the first subset) may be a sum of counts of MAC operations associated with adjoining NN layers (such as NN layers 1, 2 and 3) of the set of NN layers that may be grouped in the subset. Further, the count of MAC operations associated with each subset may be less than or equal to the size of the processing capability of the first electronic device 102.

In accordance with an embodiment, the first electronic device 102 may be configured to determine a size of the working memory 120 of the second electronic device 104. The first electronic device 102 may also determine a network communication capability that indicates a transmission bandwidth of the second electronic device 104 and a reception bandwidth of the second electronic device 104. The size of the working memory 120, the transmission bandwidth, and the reception bandwidth may be received from the second electronic device 104. Thereafter, the first electronic device 102 may determine a subset of adjoining NN layers of the set of NN layers of the neural network model 116. The determination may be based on a grouping of the adjoining NN layers based on at least one of the size of the working memory 120, the network communication capability of the first electronic device 102, and/or the network communication capability of the second electronic device 104. The network communication capability of the first electronic device 102 and that of the second electronic device 104 may be determined based on a type (such as wired connection, Wi-Fi, or Bluetooth®) of connection between the first electronic device 102 and the second electronic device 104.

In an example scenario, the first electronic device 102 may group NN layer-6 and NN-layer 7 (i.e., adjoining NN layers) to determine a first subset. The determination may be performed based on a memory footprint of each of the NN layers 6 and 7, the transmission bandwidth of the first electronic device 102, and the reception bandwidth of the second electronic device 104. Similarly, NN layers 8, 9, and 10 (adjoining NN layers) may be grouped to determine a second subset. The determination may be based on a memory footprint of each of the NN layers 8, 9, and 10, the transmission bandwidth of the first electronic device 102, and the reception bandwidth of the second electronic device 104. The first electronic device 102 may determine the partition of the neural network model 116 based on the grouping of the adjoining NN layers into the first subset and the second subset.

The memory footprint of the first subset may be a sum of memory footprints of the adjoining NN layers 6 and 7. The memory footprint of the first subset may be less than or equal to the size of the working memory 120 of the second electronic device 104. Similarly, the memory footprint of the second subset may be a sum of memory footprints of the adjoining NN layers 8, 9, and 10. The memory footprint of the second subset may be less than or equal to the size of the working memory 120 of the second electronic device 104. Further, a bandwidth required for transmission of the first subset (i.e., NN layers 6-7) or the second subset (i.e., NN layers 8-10) may be less than or equal to the transmission bandwidth supported by the first electronic device 102, and a bandwidth required for reception of the first subset or the second subset may be less than or equal to the reception bandwidth supported by the second electronic device 104.

In accordance with an embodiment, the first electronic device 102 may be further configured to detect personal or sensitive (e.g., confidential Electronic Health Record (HER) data or face information) data in the input 124. Based on the detection, the first electronic device 102 may determine one or more NN layers of the set of NN layers that receive the input 124. For example, an initial NN layer of a set of NN layers may receive a face image as the input 124. Other subsequent NN layers (e.g., layer 3 onwards) may apply convolutions and other operations on the face image to generate several latent image representations as respective layer outputs. Since it may not be possible to identify the face from such latent representations, other layers may be divided into subsets and transmitted as sub-models to other electronic devices (such as the second electronic device 104). Such sub-models may only require the latent image representations as input and may not pose any privacy concern regarding disclosure of a person's identity or facial information without the consent of the person. Thus, adjoining NN layers of the neural network model 116 may be grouped based on the constraint information (i.e., the size of the working memory 114, the processing capability, the network communication capability, and content of the input 124) and the analysis of each of the NN layers of the neural network model 116. The partition of the neural network model 116 may be determined based on the grouping of the adjoining NN layers (such as NN layers 1, 2, and 3, NN layers 4 and 5, NN layers 6 and 7, or NN layers 8, 9, and 10) into the plurality of subsets of NN layers.

The first electronic device 102 may be further configured to extract a plurality of sub-models from the neural network model 116 based on the partition. For the extraction of the plurality of sub-models, the neural network model 116 may be partitioned based on the plurality of subsets of NN layers. Each subset of the plurality of subsets of NN layers may correspond to a sub-model of the plurality of sub-models. For example, the extracted plurality of sub-models may include the sub-models 122A, 122B, 122C, and 122D. The NN layers 1, 2, and 3 in the first subset may correspond to the sub-model 122A. Similarly, the NN layers 4 and 5 in a second subset may correspond to the sub-model 122B. The NN layers 6 and 7 in the third subset may correspond to the sub-model 122C; and the NN layers 8, 9, and 10 in the fourth subset, may correspond to the sub-model 122D.

The first electronic device 102 may be further configured to receive the input 124 associated with a machine learning task (such as face recognition, voice recognition, feature detection, object detection, sentiment analysis, emotion classification, and so on). For example, the input 124 may include an image, an audio, a video, a structured or unstructured dataset, or a combination thereof.

The first electronic device 102 may be further configured to execute a first set of operations for each sub-model of the plurality of sub-models 122A-122B. The first set of operations may include a first operation to load the sub-model (for example, the sub-model 122A) in the working memory 114 of the first electronic device 102. Once the sub-model 122A is loaded in the working memory 114, the first electronic device 102 may perform a second operation of the first set of operations to generate an intermediate result based on the application of the sub-model 122A on the input 124. The generation of the intermediate result may be based on execution of a set of MAC operations associated with the NN layers of the first subset. Once the intermediate result is generated, a third operation of the first set of operations may be performed to unload the sub-model 122A from the working memory 114 of the first electronic device 102. The third operation may be performed to load a next sub-model (for example, the sub-model 122B) in the working memory 114. The sub-model 122A may be unloaded since the working memory 114 may not be sufficient to load two or more sub-models at a time. The first set of operations may further include a fourth operation to store the intermediate result in the persistent storage 110.

The first electronic device 102 may be further configured to repeat the execution of the first set of operations for a next sub-model (i.e., the sub-model 122B) of the plurality of sub-models to generate an output. For example, the first electronic device 102 may load the sub-model 122B in the working memory 114. The intermediate result (generated as an output of the sub-model 122A) may be the input to the sub-model 122B. The first electronic device 102 may apply the loaded sub-model 122B on the output of the sub-model 122A to generate the intermediate result 126 (which may be an output of the sub-model 122B). In some embodiments, the first set of operations may be executed for all sub-models extracted from the neural network model 116. Therefore, none of the extracted sub-models may be transmitted to other electronic devices and the first set of operations may be repeated for the sub-model 122C to generate an intermediate result (as an output of the sub-model 122C). Thereafter, the first set of operations may be repeated for the sub-model 122D to finally generate the output 128. The output 128 may be the output (i.e., a desired output) of the neural network model 116.

The first electronic device 102 may be further configured to control a first display device to render the output (i.e., the intermediate result 126). In some embodiments, the first display device may be controlled to render the output 128. The first display device may be communicatively coupled to the first electronic device 102. For example, if the machine learning task is face recognition and the input is an image that depicts the face of an individual, the rendered output (i.e., the output 128) may include the name, the age, or the gender, of the individual.

In accordance with an embodiment, the first electronic device 102 may be configured to distribute (i.e., transmit) the extracted sub-models 122C and 122D and the intermediate result 126 (i.e., the output of the sub-model 122B) to the second electronic device 104. The bandwidth required for the transmission may be less than or equal to the transmission bandwidth of the first electronic device 102. Further, the bandwidth required for a reception (by the second electronic device 104) of the extracted sub-models 122C and 122D and the intermediate result 126 may be less than or equal to the reception bandwidth of the second electronic device 104. The first electronic device 102 may be configured to control the second electronic device 104 to execute a second set of operations for the sub-models 122C and 122D received from the first electronic device 102.

The second set of operations may include a fifth operation to load the sub-model (for example, the sub-model 122C) in the working memory 120 of the second electronic device 104. After the loading of the sub-model 122C, a sixth operation of the second set of operations may be performed. The sixth operation may include an application of the sub-model 122C on the intermediate result 126 (i.e., output of the sub-model 122B) for generation of a result (as an output of the sub-model 122C). Once the result is generated, a seventh operation of the second set of operations may be performed to unload the sub-model 122C from the working memory 120 of the second electronic device 104. Thereafter, an eighth operation of the second set of operations may be performed to render the result (generated as the output of the sub-model 122C) on a second display device. The second display device may be communicatively coupled to the second electronic device 104.

In accordance with an embodiment, the first electronic device 102 may control the second electronic device 104 to repeat the second set of operations for the sub-model 122D. The second electronic device 104 may load the sub-model 122D into the working memory 120. The result generated as an output of the sub-model 122C may be the input for the sub-model 122D. The first electronic device 102 may apply the sub-model 122D on the output of the sub-model 122C to generate the output 128 (which may be the output of the neural network model 116). The output 128 may be rendered on the second display device. The second set of operations may also include a ninth operation to transmit the result (i.e., the output of the sub-model 122C) or the output 128 to the first electronic device 102. It should be noted that a bandwidth required for the transmission may be less than or equal to the transmission bandwidth of the second electronic device 104. Further, a bandwidth required for a reception of the result (i.e., the output of the sub-model 122C) or the output 128 may be less than or equal to the reception bandwidth of the first electronic device 102.

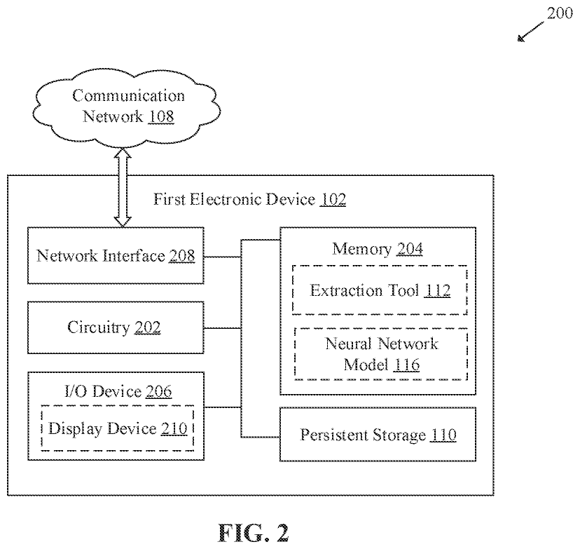

FIG. 2 is a block diagram that illustrates an exemplary first electronic device for deployment of neural network models on resource-constrained devices, in accordance with an embodiment of the disclosure. FIG. 2 is explained in conjunction with elements from FIG. 1. With reference to FIG. 2, there is shown a block diagram 200 of the first electronic device 102. The first electronic device 102 may include circuitry 202, a memory 204, an input/output (I/O) device 206, a network interface 208, and the persistent storage 110. In at least one embodiment, the I/O device 206 may also include a display device 210. The circuitry 202 may be communicatively coupled to the memory 204, the I/O device 206, the network interface 208, and the persistent storage 110, through wired or wireless communication of the first electronic device 102.

The circuitry 202 may include suitable logic, circuitry, and interfaces that may be configured to execute program instructions associated with as set of operations to be executed by the first electronic device 102. The circuitry 202 may include one or more specialized processing units, which may be implemented as an integrated processor or a cluster of processors that perform the functions of the one or more specialized processing units, collectively. The circuitry 202 may be implemented based on a number of processor technologies known in the art. Examples of implementations of the circuitry 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, and/or interfaces that may be configured to store instructions executable by the circuitry 202. The memory 204 may be configured to store operating systems and associated applications. The memory 204 may be configured to store the extraction tool 112, the neural network model 116, and the extracted plurality of sub-models 122A-122D. In at least one embodiment, the memory 204 may store the input 124, intermediate results generated as outputs of each of the plurality of sub-models 122A-122D (such as the intermediate result 126 generated by the sub-model 122A). Example implementations of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive a user input that may be indicative of selection of the neural network model 116 included in the persistent storage 110 and a size of the working memory 114 of the first electronic device 102. The user input may also be received for triggering of an analysis of the neural network model 116 or extraction of the plurality of sub-models 122A-122D from the neural network model 116. The I/O device 206 may be further configured to render an output in response to the user input. The output may include the constraint information associated deployment of the neural network model 116, the information generated based on the analysis of the neural network model 116, the neural network model 116, or the extracted plurality of sub-models 122A-122D. The rendered output may further include the input 124, intermediate results generated by the sub-models (such as the intermediate result 126), or the output 128. The I/O device 206 may include various input and output devices, which may be configured to communicate with the circuitry 202. Examples of the input devices may include, but are not limited to, a touch screen, a keyboard, a mouse, a joystick, and/or a microphone. Examples of the output devices may include, but are not limited to, the display device 210.

The network interface 208 may include suitable logic, circuitry, interfaces, and/or code that may be configured to establish a communication between the first electronic device 102, the second electronic device 104, and the server 106, via the communication network 108. The network interface 208 may be implemented by use of various known technologies to support wired or wireless communication of the first electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 208 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VOIP), light fidelity (Li-Fi), Wi-MAX, a protocol for email, instant messaging, and/or Short Message Service (SMS).

The display device 210 may include suitable logic, circuitry, interfaces, and/or code that may be configured to render the constraint information, results of the analysis of the neural network model 116, the neural network model 116, the plurality of sub-models 122A-122D, the input 124, the intermediate results generated by the extracted sub-models (such as the intermediate result 126), or the output 128. In accordance with an embodiment, the display device 210 may include a touch screen to receive the user input. The display device 210 may be realized through several known technologies such as, but not limited to, a Liquid Crystal Display (LCD) display, a Light Emitting Diode (LED) display, a plasma display, and/or an Organic LED (OLED) display technology, and/or other display technologies. In accordance with an embodiment, the display device 210 may refer to a display screen of smart-glass device, a 3D display, a see-through display, a projection-based display, an electro-chromic display, and/or a transparent display.

Like the first electronic device 102, the second electronic device 104 may include a circuitry, a memory, an I/O device, a network interface, the persistent storage 118, and a display device (such as the second display device). The second electronic device 104 may receive control instructions from the circuitry 202. The control instructions may direct the second electronic device 104 to receive sub-models (such as the sub-models 122C and 122D), store the received sub-models, execute a set of operations for each of the received sub-models for generation of an output (such as the output 128), render the output, and/or transmit the output to the first electronic device 102.

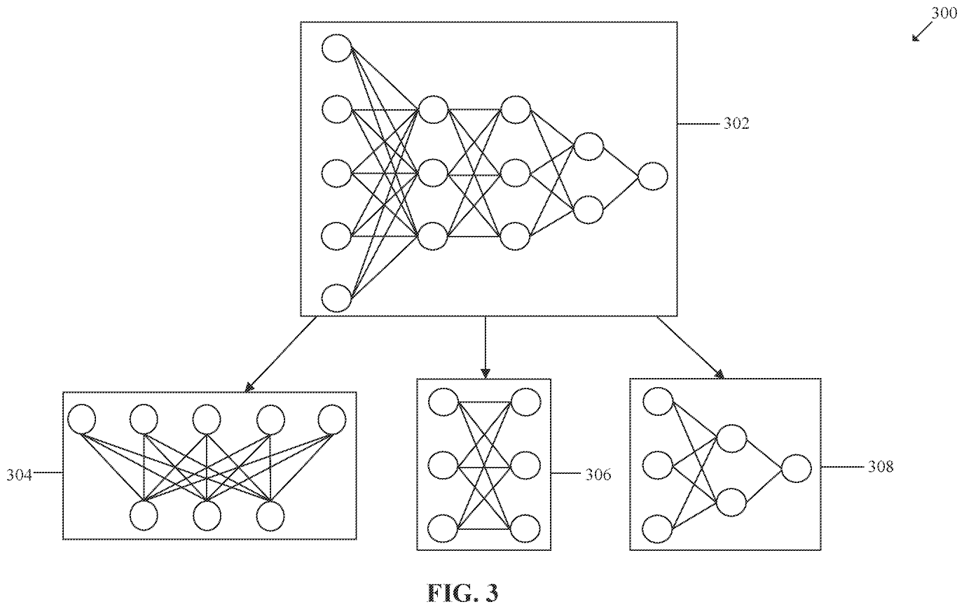

The operations executed by the first electronic device 102, as described in FIG. 1, may be performed by the circuitry 202. Operations executed by the circuitry 202 are described in detail, for example, in FIGS. 3, 4, 5, 6, and 7.

FIG. 3 is a diagram that illustrates an exemplary scenario for extraction of a plurality of sub-models from a DNN model based on constraint information, in accordance with an embodiment of the disclosure. FIG. 3 is explained in conjunction with elements from FIG. 1 and FIG. 2. With reference to FIG. 3, there is shown an exemplary scenario 300. In the exemplary scenario 300, there is shown a DNN model 302. The DNN model 302 may be an exemplary implementation of the neural network model 116. The circuitry 202 may be configured to extract three sub-models, viz., a first sub-model 304, a second sub-model 306, and a third sub-model 308 from the DNN model 302. The extraction may be based on constraint information associated with a deployment of the DNN model 302 and an analysis of a model file that includes the DNN model 302.

In accordance with an embodiment, the circuitry 202 may be configured to determine the constraint information. The constraint information may be indicative of resource constraints of the first electronic device 102. For example, the constraint information may include a size of the working memory 114 of the first electronic device 102, the processing capability of the first electronic device 102, the transmission bandwidth and the reception bandwidth of the first electronic device 102, and an indication of whether an input to the DNN model 302 includes personal or sensitive data. Based on the constraint information, the circuitry 202 may determine that the DNN model 302 is required to be partitioned into a plurality of sub-models.

The analysis of the model file may include, for example, a determination of a size of the DNN model 302, a count of a set of NN layers of the DNN model 302 and a memory footprint of the DNN model 302. The analysis of the model file may further include determination of characteristics of each NN layer of the set of NN layers. The characteristics may include, for example, a memory footprint of each NN layer of the DNN model 302, a count of MAC operations associated with each NN layer, a bandwidth requirement for transmission of each NN layer, and a number of NN layers of the DNN model 302 that may receive personal or sensitive data.

Based on the determined constraint information and results of the analysis, the circuitry 202 may determine a partition of the DNN model 302. For example, the set of NN layers in the DNN model 302 may be partitioned into three subsets of NN layers, viz., a first subset, a second subset, and a third subset. The three subsets of NN layers may correspond to the sub-models into which the DNN model 302 may be partitioned. The first subset may correspond to the first sub-model 304. Similarly, the second subset and the third subset may correspond to the second sub-model 306 and the third sub-model 308, respectively. Each subset may be determined based on a grouping of adjoining NN layers of the set of NN layers. The circuitry 202 may be configured to select a number of adjoining NN layers of the set of NN layers for the grouping such that a resource requirement for execution of the grouped layers (i.e., the determined subset) does not violate a resource constraint of the first electronic device 102.

In accordance with an embodiment, a first memory footprint of the determined first subset may be a sum of memory footprints of adjoining NN layers that may be grouped into the first subset. Similarly, a second memory footprint of the second subset may be a sum of memory footprints of adjoining NN layers grouped into the second subset, and a third memory footprint of the third subset may be a sum of memory footprints of adjoining NN layers grouped into the third subset. The circuitry 202 may be configured to group adjoining NN layers of the set of NN layers (into the three subsets) such that each of the first memory footprint, the second memory footprint, and the third memory footprint remains less than or equal to the size of the working memory 114.

In accordance with an embodiment, a first count of MAC operations associated with the determined first subset may be equal to a sum of counts of MAC operations associated with adjoining NN layers in the first subset. Similarly, a second count of MAC operations associated with the second subset may be equal to a sum of counts of MAC operations associated with adjoining NN layers in the second subset, and a third count of MAC operations associated with the third subset may be equal to a sum of counts of MAC operations associated with adjoining NN layers in the third subset. The circuitry 202 may be configured to group adjoining NN layers of the set of NN layers such that each of the first count, the second count, and the third count remains less than or equal to the processing capability. Similarly, the bandwidth requirement for a transmission of each subset of the three subsets may remain less than or equal to the transmission bandwidth. The circuitry 202 may be further configured to select adjoining NN layers of the set of NN layers for grouping based on whether the adjoining NN layers receive personal or sensitive data (e.g., Personal Identifiable Information (PII) records). For example, the circuitry 202 may detect a certain NN layer that may receive confidential data (e.g., EHR data) as an input. Based on the detection, the circuitry 202 may select the detected NN layer for grouping with other adjoining NN layers to determine a subset. A sub-model corresponding to the determined subset may be executed on the first electronic device 102. The sub-model may not be transmitted to prevent any unwanted disclosure of the confidential data to other electronic devices. In some embodiments, the circuitry 202 may select adjoining NN layers subsequent to the detected NN layer for grouping into one or more subsets. If the selected adjoining NN layers do not receive the sensitive data, then the sub-models corresponding to such layers may be transmitted to other electronic devices for execution. For transmission, it may be assumed that the bandwidth requirement for transmission of such models is less than or equal to the transmission bandwidth of the first electronic device 102.

The circuitry 202 may extract the three sub-models (i.e., the first sub-model 304, the second sub-model 306, and the third sub-model 306) based on the three determined subsets of adjoining NN layers.

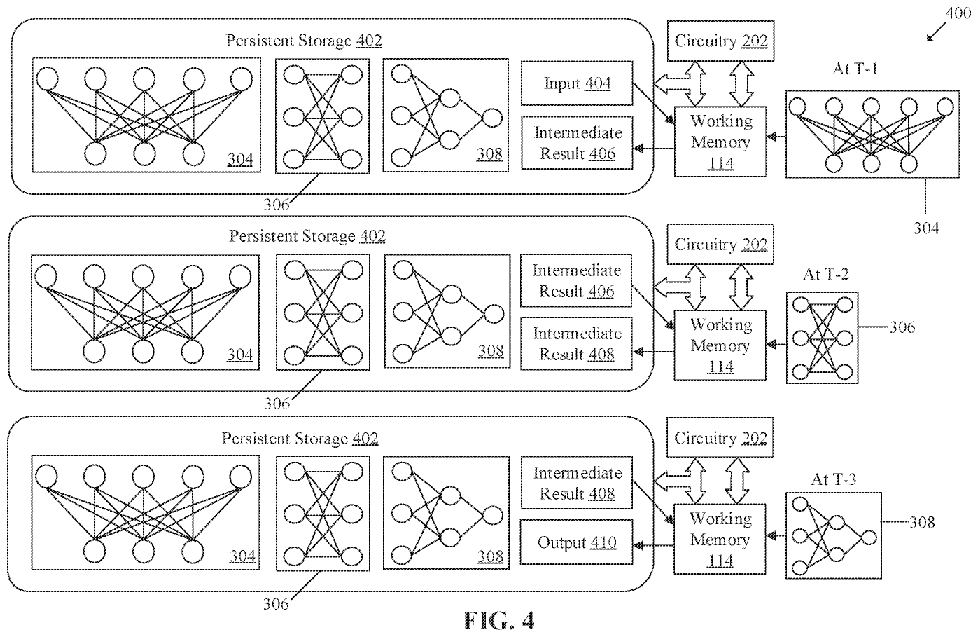

FIG. 4 is a diagram that illustrates an exemplary scenario about execution of a set of operations for sub-models extracted from a neural network model, in accordance with an embodiment of the disclosure. FIG. 4 is explained in conjunction with elements from FIG. 1, FIG. 2, and FIG. 3. With reference to FIG. 4, there is shown an exemplary scenario 400. In the exemplary scenario 400, there is shown a persistent storage 402 that is an exemplary implementation of the persistent storage 110 of FIG. 1. The persistent storage 402 may store the sub-models (i.e., the first sub-model 304, the second sub-model 306, and the third sub-model 306) extracted from the DNN model 302 of FIG. 3. The circuitry 202 may be configured to execute a set of operations for each sub-model for generation of a final output of a machine learning task. All extracted sub-models may be executed on the first electronic device 102.

At T-1, the circuitry 202 may be configured to receive an input 404. The reception of the input 404 may trigger an execution of operations associated with a machine learning task. Based on the reception of the input, the circuitry 202 may execute a set of operations. The set of operations may include, for example, four operations that may be executed for each of the first sub-model 304, the second sub-model 306, and the third sub-model 306. The first operation of the set of operations may include a loading of the first sub-model 304 in the working memory 114 of the first electronic device 102. Once the first sub-model 304 is loaded into the working memory 114, a second operation of the set of operations may be executed. The second operation may include an application of the first sub-model 304 on the input 404 for generation of an intermediate result 406 as an output of the first sub-model 304. Thereafter, a third operation of the set of operations may be executed. The third operation may include an unloading of the first sub-model 304 from the working memory 114 of the first electronic device 102. The unloading of the first sub-model 304 may be followed by a fourth operation of the set of operations. The fourth operation may include a storage of the intermediate result 406 in the persistent storage 402.

The circuitry 202 may be further configured to repeat the set of operations for subsequent sub-models, i.e., the second sub-model 306 and the third sub-model 308 at two subsequent time instances.

At T-2, the second sub-model 306 may be loaded into the working memory 114. The intermediate result 406, which may be generated as the output of the first sub-model 304, may be provided as an input to the second sub-model 306. The loading of the second sub-model 306 may be followed by an application of the second sub-model 306 on the intermediate result 406. The application may generate an intermediate result 408 as output of the second sub-model 306. The generation of the intermediate result 408 may be followed by unloading of the second sub-model 306 from the working memory 114. Thereafter, the intermediate result 408 may be stored on the persistent storage 402.

At T-3, the third sub-model 308 may be loaded into the working memory 114. The intermediate result 408, which may be generated as the output of the second sub-model 306, may be provided as an input to the third sub-model 308. The loading of the third sub-model 308 may be followed by an application of the third sub-model 308 on the intermediate result 408. The application may lead to a generation of an output 410. The output 410 (generated by the third sub-model 306) may be a final output of the DNN model 302 (i.e., a final result for the machine learning task). Thereafter, the third sub-model 308 may be unloaded from the working memory 114 and the output 410 may be stored on the persistent storage 402.

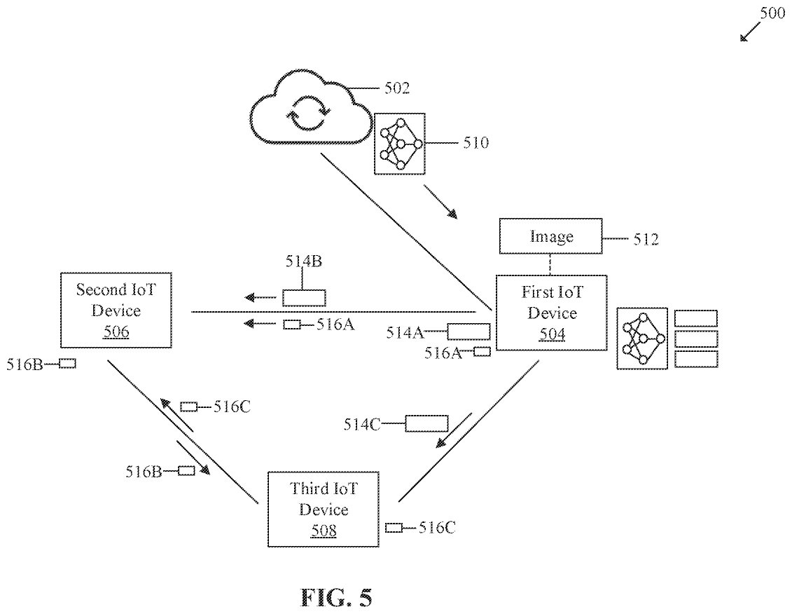

FIG. 5 is a diagram that illustrates an exemplary scenario for extraction of a plurality of sub-models from a DNN model and application of the plurality of sub-models on a plurality of devices, in accordance with an embodiment of the disclosure. FIG. 5 is explained in conjunction with elements from FIG. 1, FIG. 2, FIG. 3, and FIG. 4. With reference to FIG. 5, there is shown an exemplary scenario 500. In the exemplary scenario 500, there is shown a cloud server 502 and a set of IoT devices, viz., a first IoT device 504, a second IoT device 506, and a third IoT device 508. The cloud server 502 may store a DNN model 510. The DNN model 510 may be an exemplary implementation of the neural network model 116 of FIG. 1. The first IoT device 504 may acquire the DNN model 510 and may extract a plurality of sub-models from the DNN model 510. Thereafter, the first IoT device 504 may distribute the extracted plurality of sub-models to the second IoT device 506 and the third IoT device 508 to perform a machine learning task.

In at least one embodiment, the IoT devices of the set of IoT devices may be heterogeneous devices that may be part of a surveillance system. For example, the first IoT device 504 may be an imaging sensor (camera), the second IoT device 506 may be a smartphone, and the third IoT device 508 may be a workstation. The first IoT device 504 and the second IoT device 506 may be resource-constrained devices. The second IoT device 506 may be associated with a user of the surveillance system.

At any time, the first IoT device 504 may be configured to capture an image 512 of a person. Once the image 512 is captured, the first IoT device 504 may be required to perform a machine learning task that involves recognizing the person from the captured image 512. To perform the machine learning task, the first IoT device 504 may be configured to acquire the DNN model 510 (i.e., a model file of a pretrained DNN model) from the cloud server 502. Upon receiving the DNN model 510, the first IoT device 504 may be configured to extract a plurality of sub-models from the DNN model 510. The extraction may be necessary since the first IoT device 504 may be a memory-constrained device. The memory footprint of the DNN model 510 may be greater than a size of a working memory of the first IoT device 504.

In accordance with an embodiment, the first IoT device 504 may analyze the DNN model 510 and acquire constraint information associated with a deployment of the DNN model 510 on each of the first IoT device 504, the second IoT device 506, and the third IoT device 508. Based on the analysis of the DNN model 510 and the constraint information, the first IoT device 504 may determine a partition the DNN model 510. The first IoT device 504 may be configured to extract three sub-models, viz., a first sub-model 514A, a second sub-model 514B, and a third sub-model 514C based on the partition.

The three sub-models may be extracted such that a memory footprint of the first sub-model 514A is equal to or less than a size of working memory of the first IoT device 504 and a count of MAC operations associated with the first sub-model 514A is equal to or less than a processing capability of the first IoT device 504. Similarly, the second sub-model 514B may be extracted such that a memory footprint of the second sub-model 514B is equal to or less than a size of working memory of the second IoT device 506, a count of MAC operations associated with the second sub-model 514B is equal to or less than a processing capability of the second IoT device 506, a bandwidth required for transmission of the second sub-model 514B is less than or equal to a transmission bandwidth of the first IoT device 504, and a bandwidth required for reception of the second sub-model 514B is less than or equal to a reception bandwidth of the second IoT device 506. Similarly, the third sub-model 514C may be extracted such that a memory footprint of the third sub-model 514C is equal to or less than a size of working memory of the third IoT device 508, a count of MAC operations associated with the third sub-model 514C is equal to or less than a processing capability of the third IoT device 508, a bandwidth required for transmission of the third sub-model 514C is less than or equal to a transmission bandwidth of the first IoT device 504, and a bandwidth required for reception of the third sub-model 514C is less than or equal to a reception bandwidth of the third IoT device 508.

Once the three sub-models are extracted from the DNN model 510, the first IoT device 504 may be configured to distribute (i.e., transmit) the second sub-model 514B to the second IoT device 506 and the third sub-model 514C to the third IoT device 508. Thereafter, the first IoT device 504 may to load the first sub-model 514A into the working memory of the first IoT device 504 and may apply the first sub-model 514A on the captured image 512 (as input) to generate an intermediate result 516A as an output.

The first IoT device 504 may be further configured to transmit the intermediate result 516A and control instructions to the second IoT device 506. The first IoT device 504 may control the second IoT device 506 to load the second sub-model 514B into the working memory of the second IoT device 506 and apply the second sub-model 514B on the intermediate result 516A (as input) to generation of another intermediate result 516B as an output. The second IoT device 506 may send the intermediate result 516B to the third IoT device 508.

The first IoT device 504 may be further configured to send control instructions to the third IoT device 508. The first IoT device 504 may control the third IoT device 508 to load the third sub-model 514C into the working memory of the third IoT device 508 and apply the third sub-model 514C on the intermediate result 516B (as input) to generate an output 516C. The third IoT device 508 may send the output 516C to the second IoT device 506. The first IoT device 504 may be further configured to control the second IoT device 506 to render the output 516C on a display device. In some embodiments, the first IoT device 504 may be configured to control the third IoT device 508 to send the output 516C to the first IoT device 504. The first IoT device 504 may render the output 516C on a display device.

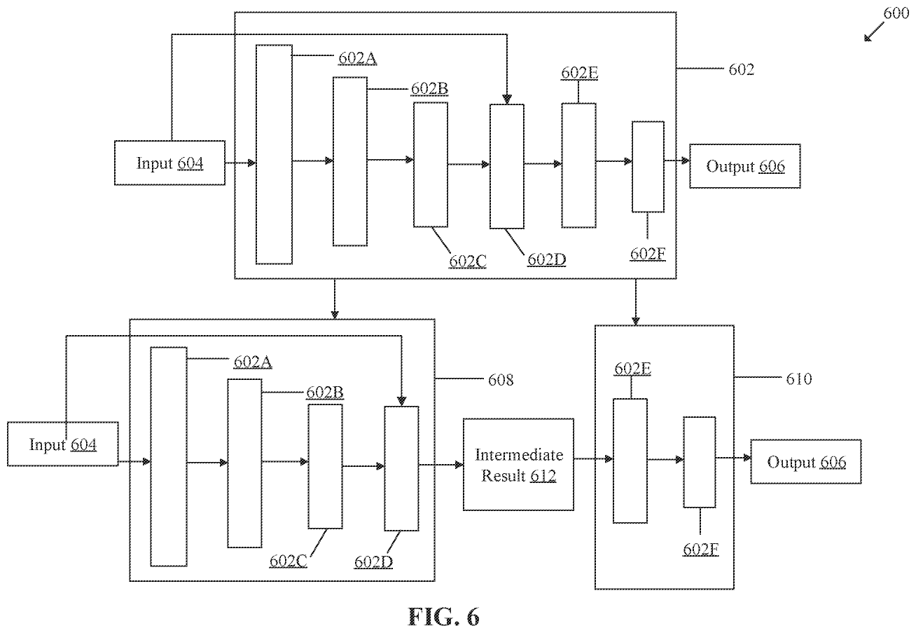

FIG. 6 is a diagram that illustrates an exemplary scenario for extraction of sub-models from a DNN model based on an input received at each layer of the DNN model, in accordance with an embodiment of the disclosure. FIG. 6 is explained in conjunction with elements from FIG. 1, FIG. 2, FIG. 3, FIG. 4, and FIG. 5. With reference to FIG. 6, there is shown an exemplary scenario 600. In the exemplary scenario 600, there is shown a DNN model 602. The DNN model 602 may be an exemplary implementation of the neural network model 116 of FIG. 1. The DNN model 602 may include a set of NN layers. The set of NN layers may include an input NN layer 602A, four intermediate NN layers 602B, 602C, 602D, and 602E, and an output NN layer 602F. The DNN model 602 may receive an input 604 and may generate an output 606 based on the input 604.

During operation, the circuitry 202 may be configured to extract a first sub-model 608 and a second sub-model 610 from the DNN model 602 based on whether NN layers of the set of layers receive the input 604. In accordance with an embodiment, the circuitry 202 may be configured to detect that the input 604 includes personal or sensitive data (e.g., PII records). Based on the detection, the circuitry 202 may determine NN layers of the DNN model 602 that receive the input 604. For instance, the circuitry 202 may determine that the input NN layer 602A and the intermediate NN layer 602D receive the input 604. Once the NN layers 602A and 602D are determined, the circuitry 202 may be further configured to determine NN layers adjoining the NN layers 602A and 602D. The circuitry 202 may determine NN layers 602E and 602F as the NN layers that are adjoining the NN layers 602A and 602D.

The circuitry 202 may group adjoining NN layers of the set of NN layers from the input layer 602A to the intermediate NN layer 602D into a first subset. Similarly, the circuitry 202 may group adjoining NN layers of the set of NN layers after the intermediate NN layer 602D into a second subset. Thus, NN layers 602E and 602F may be grouped into the second subset. The first subset and the second subset may be two disjoint sets of NN layers that may be treated as the first sub-model 608 and the second sub-model 610, respectively.

The grouping of adjoining NN layers into the first subset (i.e., first sub-model 608) may be such that a memory footprint of the first sub-model 608 does not exceed the size of the working memory 114 of the first electronic device 102. The count of MAC operations associated with the first subset (i.e., first sub-model 608) may not exceed the processing capability of the first electronic device 102. Similarly, the grouping of adjoining NN layers into the second subset (i.e., the second sub-model 610) may be such that a memory footprint of the second subset (i.e., the second sub-model 610) does not exceed the size of the working memory 114 of the first electronic device 102 or a size of a working memory of another electronic device (such as the second electronic device 104) that may receive the second subset (i.e., the second sub-model 610). The count of MAC operations associated with the second subset (i.e., the second sub-model 610) may not exceed the processing capability of the first electronic device 102 or the second electronic device 104. Further, a bandwidth requirement for transmission of the second sub-model 610 may not exceed the transmission bandwidth of the first electronic device 102 and a bandwidth requirement for reception of the second sub-model 610 may not exceed the reception bandwidth of the second electronic device 104.

The first sub-model 608 may not be distributed to other electronic devices for protection of the sensitive data (e.g., PII records). The second sub-model 610 may be distributed to the second electronic device 104. The first sub-model 608 may generate an intermediate result 612 as output based on an application of the first sub-model 608 on the input 604. The intermediate result 612 may be transmitted to the second electronic device 104. The output 606 may be generated based on an application of the second sub-model 610 on the intermediate result 612.

The grouping of adjoining NN layers of the set of NN layers into two subsets (in FIG. 6) is merely shown as an example and such an example should not be construed as limiting the disclosure. In some embodiments, the grouping may result in more than two subsets.

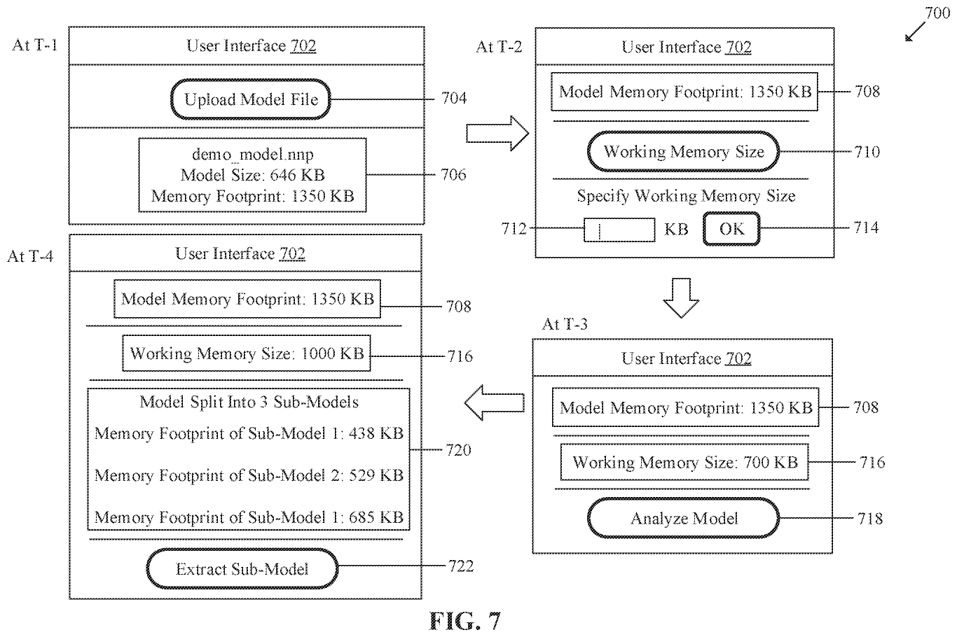

FIG. 7 is a diagram that illustrates an exemplary scenario for rendering of a partition of a DNN model, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown an exemplary scenario 700. In the exemplary scenario 700, there is shown a user interface 702 of the extraction tool 112. The circuitry 202 may control the user interface 702 to render a partition of a neural network model. The partition of the neural network model may be determined based on constraint information associated with a deployment of a DNN model on the first electronic device 102 and a model file that includes the neural network model. The user interface 702 may be rendered on the first electronic device 102 or the first display device.

At T-1, the circuitry 202 may control the user interface 702 to render user interface elements 704 and 706. The user interface element 704 may be a radio button (for example, “upload model file”). The user interface element 706 may indicate information associated with the neural network model included in the model file. The information may include a model file type (for example, .nnp), a size of the DNN model (for example, 646 KB), and a memory footprint of the neural network model (for example, 1350 KB).

Based on a reception of a user input via the user interface element 704, the circuitry 202 may be configured to render, at time T-2, user interface elements 708, 710, 712, and 714. The memory footprint of the neural network model may be indicated on the user interface element 708.

The user interface element 710 may be a radio button (for example, “working memory size”). The circuitry 202 may be configured to determine the size of the working memory 114 of the first electronic device 102 based on a reception of a user input via the interface element 710.

The user interface element 712 may be a textbox that may allow a user to enter the size of the working memory 114 and the user interface element 714 may be a radio button (for example, “ok”) that allows the user to submit the entered size of the working memory 114.

Based on reception of a user input via the user interface element 710 or the user interface element 712, the circuitry 202 may be configured to render, at time T-3, user interface elements 708, 716, and 718. The user interface element 716 may indicate the determined size of the working memory 114 or the entered size of the working memory 114 (for example, 700 KB). The user interface element 718 may be a radio button (for example, “analyze model”). The circuitry 202 may be configured to analyze a set of NN layers of the neural network model based on a reception of a user input via the user interface element 718.

Based on the reception of a user input via the user interface element 718, the circuitry 202 may be configured render, at time T-4, user interface elements 708, 716, 720 and 722. The user interface element 720 may indicate a partition of the neural network model that may be determined based on an analysis of the set of NN layers of the neural network model. The analysis may be performed based on the memory footprint of the neural network model (which may be indicated in user interface element 708), the size of the working memory 114 (which may be indicated in user interface element 716), and memory footprint of each NN layer of the set of NN layers.

For example, the determined partition may indicate that the set of NN layers may be partitioned into three subsets of NN layers based on three groupings of adjoining NN layers of the set of NN layers. The subsets may correspond to sub-models. The sub-models may include a sub-model 1 with a memory footprint of 438 KB, a sub-model 2 with a memory footprint of 529 KB, and a sub-model 3 with a memory footprint of 685 KB. The memory footprint of each sub-model may be an accumulation of memory footprints of adjoining NN layers in a corresponding subset. Further, the memory footprint of the subset (or a sub-model) may be less than the working memory 114.

The user interface element 722 may be a radio button (for example, “extract sub-model”). Upon receiving a user input via the user interface element 722, the circuitry 202 may be configured to extract sub-models based on the determined partition.

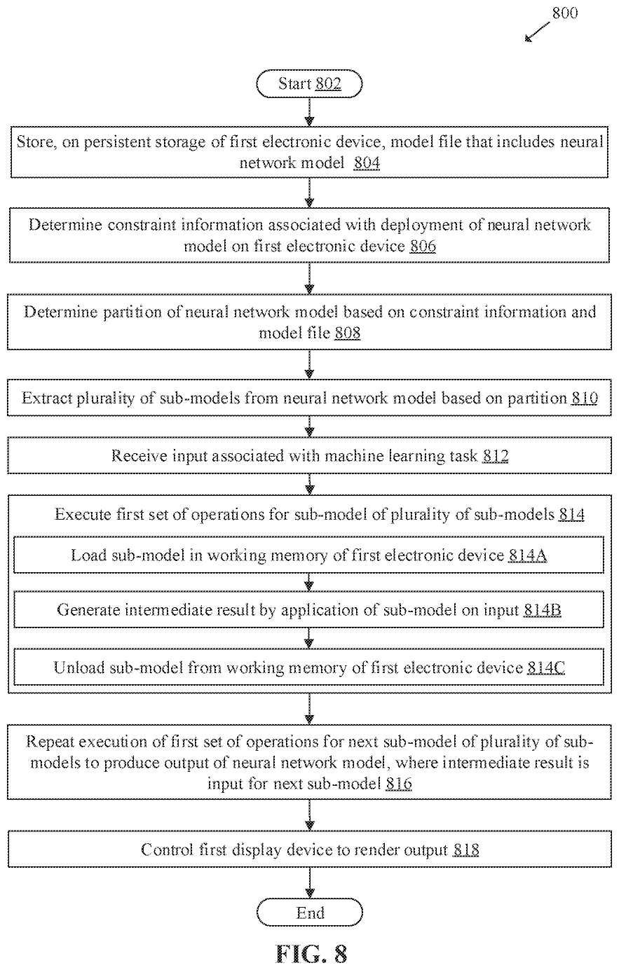

FIG. 8 is a flowchart that illustrates operations for an exemplary method for deployment of neural network models on resource-constrained devices, in accordance with an embodiment of the disclosure. FIG. 8 is explained in conjunction with elements from FIG. 1, FIG. 2, FIG. 3, FIG. 4, FIG. 5, and FIG. 6 and FIG. 7. With reference to FIG. 8, there is shown a flowchart 800. The operations from 802 to 818 may be implemented by any computing system, such as, by the first electronic device 102, or the circuitry 202 of the first electronic device 102, of FIG. 1. The operations may start at 802 and may proceed to 804.

At 804, a model file that includes the neural network model 116 may be stored on the persistent storage 110 of the first electronic device 102. In at least one embodiment, the circuitry 202 may be configured to store, on the persistent storage 110 of the first electronic device 102, the model file that includes the neural network model 116.

At 806, constraint information associated with a deployment of the neural network model 116 on the first electronic device 102 may be determined. In at least one embodiment, the circuitry 202 may be configured to determine the constraint information associated with the deployment of the neural network model 116 on the first electronic device 102. The details of determination of the constraint information, is described, for example, in FIG. 1, FIG. 3, FIG. 5, FIG. 6, and FIG. 7.

At 808, a partition of the neural network model 116 may be determined based on the constraint information and the model file. In at least one embodiment, the circuitry 202 may be configured to determine the partition of the neural network model 116 based on the constraint information and the model file. The details of determination of the partition, is described, for example, in FIG. 1, FIG. 3, FIG. 5, FIG. 6, and FIG. 7.

At 810, a plurality of sub-models may be extracted from the neural network model 116 based on the partition. In at least one embodiment, the circuitry 202 may be configured to extract the plurality of sub-models from the neural network model 116 based on the partition. The details of extraction of the plurality of sub-models are described, for example, in FIG. 1, FIG. 3, FIG. 5, FIG. 6, and FIG. 7.

At 812, the input 124 associated with a machine learning task may be received. In at least one embodiment, the circuitry 202 may be configured to receive the input 124 associated with the machine learning task. The details of reception of the input 124, are described, for example, FIG. 1 and FIG. 3.

At 814, a first set of operations for a sub-model of the plurality of sub-models may be executed. In at least one embodiment, the circuitry 202 may be configured to execute the first set of operations for the sub-model of the plurality of sub-models. The first set of operations may include an operation 814A, an operation 814B, and an operation 814C.

At 814A, the sub-model may be loaded in the working memory 114 of the first electronic device 102. In at least one embodiment, the circuitry 202 may be configured to load the sub-model in the working memory 114 of the first electronic device 102. At 814B, an intermediate result may be generated by an application of the sub-model on the input 124. In at least one embodiment, the circuitry 202 may be configured to generate the intermediate result by an application of the sub-model on the input 124. At 814C, the sub-model may be unloaded from the working memory 114 of the first electronic device 102. In at least one embodiment, the circuitry 202 may be configured to unload the sub-model from the working memory 114 of the first electronic device 102. The details of execution of the first set of operations are described, for example, in FIG. 1, FIG. 4, FIG. 5, and FIG. 6.

At 816, the execution of the first set of operations for a next sub-model of the plurality of sub-models may be repeated to generate an output. In at least one embodiment, the circuitry 202 may be configured to repeat the execution of the first set of operations for the next sub-model of the plurality of sub-models to generate the output. The intermediate result may be the input for the next sub-model.

At 818, a first display device (i.e., the display device 210) may be controlled to render the output. In at least one embodiment, the circuitry 202 may be configured to control the first display device (i.e., the display device 210) to render the output. The details rendering of the output, are described, for example, in FIG. 1. Control may pass to end.

Although the flowchart 800 is illustrated as discrete operations, such as 804, 806, 808, 810, 812, 814, 816, and 818, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the first electronic device 102). The computer-executable instructions may cause the machine and/or computer to perform operations that include storing, on the persistent storage 110 of the first electronic device 102, a model file that may include the neural network model 116. The operations may further include a determination of constraint information associated with a deployment of the neural network model 116 on the first electronic device 102 and a determination of a partition of the neural network model 116 based on the constraint information and the model file. The operations may further include extraction of a plurality of sub-models from the neural network model 116 based on the partition. The operations may further include a reception of the input 124 that may be associated with a machine learning task and execution of a first set of operations for a sub-model of the plurality of sub-models. The first set of operations may include a first operation of loading the sub-model in the working memory 114 of the first electronic device 102, a second operation of generation of an intermediate result by an application of the sub-model on the input 124, and a third operation of unloading the sub-model from the working memory 114 of the first electronic device 102. The operations may further include repetition of the execution of the first set of operations for a next sub-model of the plurality of sub-models for generation of an output. The intermediate result may be the input for the next sub-model. The operations may further include controlling of a first display device to render the output.

Exemplary aspects of the disclosure may include a method that may be implemented on an electronic device (such as, the first electronic device 102 of FIG. 1) that may include circuitry (such as the circuitry 202). The method may include storing, on the persistent storage 110 of the first electronic device 102, the model file that may include a neural network model (i.e., the neural network model 116). The method may include determining constraint information associated with a deployment of the neural network model 116 on the first electronic device 102. The constraint information may include at least one of a size of the working memory 114 of the first electronic device 102, a processing capability of the first electronic device 102 to perform a count of MAC operations per second, a network communication capability indicative of a transmission bandwidth of the first electronic device 102 and a reception bandwidth of the first electronic device 102, and an indication that the input 124 includes personal or sensitive data. The method may further include determining a partition of the neural network model 116 based on the constraint information and the model file and extracting a plurality of sub-models from the neural network model 116 based on the partition. Each sub-model of the plurality of sub-models may include a subset of a set of NN layers of the neural network model 116. The method may further include receiving the input 124 that may be associated with a machine learning task and executing a first set of operations for a sub-model of the plurality of sub-models. The first set of operations may include a first operation to load the sub-model in the working memory 114 of the first electronic device 102, a second operation to generate an intermediate result by an application of the sub-model on the input 124, and a third operation to unload the sub-model from the working memory of the first electronic device 102. The first set of operations may further include a fourth operation to store the intermediate result in the persistent storage 110. The method may further include repeating the execution of the first set of operations for a next sub-model of the plurality of sub-models to generate an output. The intermediate result may be the input for the next sub-model. The method may further include controlling the first display device to render the output.

In accordance with an embodiment, the method further comprises determining a memory footprint of each NN layer of a set of NN layers of the neural network model 116. The memory footprint may be indicative of a memory required to load a corresponding NN layer on the working memory 114 of the first electronic device 102 as part of a sub-model of the plurality of sub-models. The method further comprises grouping adjoining NN layers of the set of NN layers into a plurality of subsets of NN layers based on the determined memory footprint of each NN layer. A memory footprint of each subset may be less than or equal to the size of the working memory 114 of the first electronic device 102. The partition of the neural network model 116 may be further determined based on the grouping of the adjoining NN layers of the set of NN layers. The memory footprint of each NN layer may be determined based on a size of the corresponding NN layer, a size of an input to be received by the corresponding NN layer, a size of an output to be generated by the corresponding NN layer, and a size of a buffer to be allocated to the corresponding NN layer. The memory footprint of each subset of the plurality of subsets of NN layers may be a sum of memory footprints of adjoining NN layers of the set of NN layers that may be grouped into a corresponding subset of the plurality of subsets. The determined memory footprint of each NN layer of the set of NN layers of the neural network model 116 may be less than or equal to the size of the working memory 114 of the first electronic device 102.

In accordance with an embodiment, the method further comprises determining a count of MAC operations associated with each NN layer of a set of NN layers of the neural network model 116. The method further comprises grouping adjoining NN layers of the set of NN layers into a plurality of subsets of NN layers based on the determined count of MAC operations associated with each NN layer. A count of MAC operations associated with each subset may be less than or equal to the processing capability of the first electronic device 102. The partition of the neural network model 116 may be further determined based on the plurality of subsets of NN layers. The count of MAC operations associated with each subset may be a sum of counts of MAC operations associated with adjoining NN layers of the set of NN layers that may be grouped into a corresponding subset of the plurality of subsets of NN layers. The determined count of MAC operations associated with each NN layer of the set of NN layers of the neural network model 116 may be less than or equal to the processing capability of the first electronic device 102.

In accordance with an embodiment, the method further comprises partitioning the neural network model 116 based on the plurality of subsets of NN layers. Each subset of the plurality of subsets of NN layers may correspond to a sub-model of the plurality of sub-models. The plurality of sub-models may be extracted further based on the partitioning.

In accordance with an embodiment, the method further comprises determining a size of the working memory 120 of the second electronic device 104. The method further comprises determining a network communication capability indicative of a transmission bandwidth of the second electronic device 104 and a reception bandwidth of the second electronic device 104. The method further comprises determining a subset of adjoining NN layers of a set of NN layers of the neural network model 116 by grouping the adjoining NN layers based on at least one of: the size of the working memory 120 of the second electronic device 104, the network communication capability of the first electronic device 102, and the network communication capability of the second electronic device 104. The determined subset of the adjoining NN layers may be a sub-model of the plurality of sub-models. A memory footprint of the determined subset may be a sum of memory footprints of the adjoining NN layers of the set of NN layers. A memory footprint of the subset may be less than or equal to the size of the working memory 120 of the second electronic device 104.

In accordance with an embodiment, the method further comprises detecting personal or sensitive data in the input 124. The method further comprises determining, based on the detection, one or more NN layers of the set of NN layers that receive the input 124. The adjoining NN layers in the determined subset may be subsequent to each of the determined one or more NN layers of the set of NN layers.

In accordance with an embodiment, the method further comprises transmitting the extracted sub-model and the intermediate result to the second electronic device 104. A bandwidth required for the transmission may be less than or equal to the transmission bandwidth of the first electronic device 102. A bandwidth required for a reception of the extracted sub-model and the intermediate result, by the second electronic device 104, may be less than or equal to the reception bandwidth of the second electronic device 104.

In accordance with an embodiment, the method further comprises controlling the second electronic device 104 to execute a second set of operations for the received sub-model. The second set of operations may include a fifth operation to load the sub-model in a working memory 120 of the second electronic device 104, a sixth operation to generate a result by an application of the sub-model on the output, a seventh operation to unload the sub-model from the working memory 120 of the second electronic device 104, and an eighth operation to render the result on a second display device. The second set of operations may further include a ninth operation to transmit the result to the first electronic device 102. A bandwidth required for the transmission may be less than or equal to the transmission bandwidth of the second electronic device 104. A bandwidth required for a reception of the result, by the first electronic device 102, is less than or equal to the reception bandwidth of the first electronic device 102.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A method, comprising:
storing, on a persistent storage of a first electronic device, a model file that includes a neural network model;
determining constraint information associated with a deployment of the neural network model on the first electronic device;
determining a partition of the neural network model based on the constraint information and the model file;
extracting a plurality of sub-models from the neural network model based on the partition;
receiving an input associated with a machine learning task;
executing a first set of operations for a sub-model of the plurality of sub-models, wherein the first set of operations comprises:
a first operation to load the sub-model in a working memory of the first electronic device;
a second operation to generate an intermediate result by an application of the sub-model on the input;
a third operation to unload the sub-model from the working memory of the first electronic device;
repeating the execution of the first set of operations for a next sub-model of the plurality of sub-models to generate an output, wherein the intermediate result is the input for the next sub-model; and
controlling a first display device to render the output.

2. The method according to claim 1, wherein each sub-model of the plurality of sub-models includes a subset of a set of NN layers of the neural network model.

3. The method according to claim 1, wherein the first set of operations further comprises a fourth operation to store the intermediate result in the persistent storage.

4. The method according to claim 1, wherein the constraint information includes at least one of:
a size of the working memory of the first electronic device,
a processing capability of the first electronic device to perform a count of multiply-accumulate (MAC) operations per second,
a network communication capability indicative of a transmission bandwidth of the first electronic device and a reception bandwidth of the first electronic device, and
an indication that the input includes personal or sensitive data.

5. The method according to claim 4, further comprising:
determining a memory footprint of each NN layer of a set of NN layers of the neural network model,
wherein the memory footprint is indicative of a memory required to load a corresponding NN layer on the working memory of the first electronic device as part of a sub-model of the plurality of sub-models; and
grouping adjoining NN layers of the set of NN layers into a plurality of subsets of NN layers based on the determined memory footprint of each NN layer,
wherein a memory footprint of each subset is less than or equal to the size of the working memory of the first electronic device, and
the partition of the neural network model is further determined based on the grouping of the adjoining NN layers of the set of NN layers.

6. The method according to claim 5, further comprising partitioning the neural network model based on the plurality of subsets of NN layers, wherein
each subset of the plurality of subsets of NN layers corresponds to a sub-model of the plurality of sub-models, and
the plurality of sub-models is extracted further based on the partitioning.

7. The method according to claim 5, wherein
the memory footprint of each NN layer is determined based on a size of the corresponding NN layer, a size of an input to be received by the corresponding NN layer, a size of an output to be generated by the corresponding NN layer, and a size of a buffer to be allocated to the corresponding NN layer, and
the memory footprint of each subset of the plurality of subsets of NN layers is a sum of memory footprints of adjoining NN layers of the set of NN layers that are grouped into a corresponding subset of the plurality of subsets.

8. The method according to claim 5, wherein the determined memory footprint of each NN layer of the set of NN layers of the neural network model is less than or equal to the size of the working memory of the first electronic device.

9. The method according to claim 4, further comprising:
determining a count of MAC operations associated with each NN layer of a set of NN layers of the neural network model; and
grouping adjoining NN layers of the set of NN layers into a plurality of subsets of NN layers based on the determined count of MAC operations associated with each NN layer, wherein
a count of MAC operations associated with each subset is less than or equal to the processing capability of the first electronic device, and
the partition of the neural network model is further determined based on the plurality of subsets of NN layers.

10. The method according to claim 9, further comprising partitioning the neural network model based on the plurality of subsets of NN layers, wherein
each subset of the plurality of subsets of NN layers corresponds to a sub-model of the plurality of sub-models, and
the plurality of sub-models is extracted further based on the partitioning.

11. The method according to claim 9, wherein the count of MAC operations associated with each subset is a sum of counts of MAC operations associated with adjoining NN layers of the set of NN layers that may be grouped into a corresponding subset of the plurality of subsets of NN layers.

12. The method according to claim 9, wherein the determined count of MAC operations associated with each NN layer of the set of NN layers of the neural network model is less than or equal to the processing capability of the first electronic device.

13. The method according to claim 4, further comprising:
determining a size of a working memory of a second electronic device;
determining a network communication capability indicative of a transmission bandwidth of the second electronic device and a reception bandwidth of the second electronic device; and
determining a subset of adjoining NN layers of a set of NN layers of the neural network model by grouping the adjoining NN layers based on at least one of the size of the working memory of the second electronic device, the network communication capability of the first electronic device, and the network communication capability of the second electronic device,
wherein the determined subset of the adjoining NN layers is a sub-model of the plurality of sub-models.

14. The method according to claim 13, wherein
a memory footprint of the determined subset is a sum of memory footprints of the adjoining NN layers of the set of NN layers, and
a memory footprint of the subset is less than or equal to the size of the working memory of the second electronic device.

15. The method according to claim 13, further comprising:
detecting personal or sensitive data in the input; and
determining, based on the detection, one or more NN layers of the set of NN layers that receive the input,
wherein the adjoining NN layers in the determined subset are subsequent to each of the determined one or more NN layers of the set of NN layers.

16. The method according to claim 13, further comprising transmitting the extracted sub-model and the intermediate result to the second electronic device, wherein
a bandwidth required for the transmission is less than or equal to the transmission bandwidth of the first electronic device, and
a bandwidth required for a reception of the extracted sub-model and the intermediate result, by the second electronic device, is less than or equal to the reception bandwidth of the second electronic device.

17. The method according to claim 13, further comprising controlling the second electronic device to execute a second set of operations for the received sub-model, wherein the second set of operations comprises:
a fifth operation to load the sub-model in a working memory of the second electronic device;
a sixth operation to generate a result by an application of the sub-model on the output;
a seventh operation to unload the sub-model from the working memory of the second electronic device; and
an eighth operation to render the result on a second display device.

18. The method according to claim 17, wherein the second set of operations further comprises a ninth operation to transmit the result to the first electronic device,
a bandwidth required for the transmission is less than or equal to the transmission bandwidth of the second electronic device, and
a bandwidth required for a reception of the result, by the first electronic device, is less than or equal to the reception bandwidth of the first electronic device.

19. A first electronic device, comprising:
a memory configured to store a model file that includes a neural network model; and
circuitry configured to:
determine constraint information associated with a deployment of the neural network model on the first electronic device;
determine a partition of the neural network model based on the constraint information and the model file;
extract a plurality of sub-models from the neural network model based on the partition;
receive an input associated with a machine learning task;
execute a first set of operations for a sub-model of the plurality of sub-models, wherein the first set of operations comprises;
a first operation to load the sub-model in a working memory of the first electronic device;
a second operation to generate an intermediate result by an application of the sub-model on the input;
a third operation to unload the sub-model from the working memory of the first electronic device;
repeat the execution of the first set of operations for a next sub-model of the plurality of sub-models to generate an output, wherein the intermediate result is the input for the next sub-model; and
control a first display device to render the output.

20. A non-transitory computer-readable medium having stored thereon, computer executable instructions that, when executed by an electronic device, causes the electronic device to perform operations, the operations comprising:
storing, on a persistent storage of a first electronic device, a model file that includes a neural network model;
determining constraint information associated with a deployment of the neural network model on the first electronic device;
determining a partition of the neural network model based on the constraint information and the model file;
extracting a plurality of sub-models from the neural network model based on the partition;
receiving an input associated with a machine learning task;
executing a first set of operations for a sub-model of the plurality of sub-models, wherein the first set of operations comprises:
a first operation to load the sub-model in a working memory of the first electronic device;
a second operation to generate an intermediate result by an application of the sub-model on the input;
a third operation to unload the sub-model from the working memory of the first electronic device;
repeating the execution of the first set of operations for a next sub-model of the plurality of sub-models to generate an output, wherein the intermediate result is the input for the next sub-model; and
controlling a first display device to render the output.
